(19) United States
(12) Patent Application Publication
(10) Pub. No.: US 2004/0236648 A1
(43) Pub. Date: Nov. 25, 2004

(54) Activity-driven, customer profitability calculation system

(75) Inventors: Patrick Yip, Morristown, NJ (US); Praveen Reddy, Jersey City, NJ (US)

Correspondence Address: McDERMOTT, WILL & EMERY, 600 13th Street, N.W., Washington, DC, 20005-3096, US

(73) Assignee: PERSHING INVESTMENTS, LLC

(21) Appl. No.: 10/851,068

(22) Filed: May 24, 2004

Related U.S. Application Data
(60) Provisional application No. 60/472,422, filed on May 22, 2003.
(60) Provisional application No. 60/472,412, filed on May 22, 2003.
(60) Provisional application No. 60/472,748, filed on May 23, 2003.
(60) Provisional application No. 60/472,747, filed on May 23, 2003.

(51) Int. Cl. G06F 17/60

(52) U.S. Cl. 705/30

(57) ABSTRACT

An activity-driven, profitability calculation method and system track expenses and/or income associated with each activity initiated by customers or accounts. The method detects and identifies activities associated with an account, and obtains rate information associated with the identified activities. The rate information specifies any expenses or incomes associated with the identified activities. A profitability status related to the account, such as an amount of profits or loss, is updated based on the rate information associated with the identified activities. The determined profitability status of the account or customer may be used to determine a service type or level that would be received by the account or customer.

### RELATED APPLICATIONS

This application claims the benefit of priority from the following U.S. Provisional Patent Applications: U.S. Provisional Patent Application Serial No. 60/472,422, titled “CUSTOMER SCORING MODEL,” filed May 22, 2003, and is related to U.S. Provisional Patent Application Serial No. 60/472,412, titled “LIFETIME REVENUE MODEL,” filed May 22, 2003; U.S. Provisional Patent Application Serial No. 60/472,748, titled “FINANCE DATA MART ACCOUNT PROFITABILITY MODEL,” filed May 23, 2003; and U.S. Provisional Patent Application Serial No. 60/472,747, titled “FINANCIAL DATA MART ATTRITION ANALYSIS MODEL,” filed May 23, 2003; and is related to U.S. patent application Ser. No. ______ (attorney docket 67389-037), titled “RATING SYSTEM AND METHOD FOR IDENTIFYING DESIRABLE CUSTOMERS,” filed concurrently herewith; U.S. patent application Ser. No. ______ (attorney docket 67389-038), titled “CUSTOMER REVENUE PREDICTION METHOD AND SYSTEM,” filed concurrently herewith; and U.S. patent application Ser. No. ______ (attorney docket 67389-040), titled “METHOD AND SYSTEM FOR PREDICTING ATTRITION CUSTOMERS,” filed concurrently herewith. Disclosures of the above-identified patent applications are incorporated herein by reference in their entireties.

### FIELD OF DISCLOSURE

This disclosure generally relates to a method and system for calculating profitability of customers or accounts, and more specifically, to an activity-driven method and system that identify activities associated with accounts or customers, and access expense and/or income data of the identified activities to determine and update profitability statuses of the accounts or customers.

### BACKGROUND OF THE DISCLOSURE

It is important for a company to be able to determine profitability of a customer or an account. A company should try to keep customers that generate profits to the company, and get rid of those generating limited profits or even costing money. Thus, it is economically sound for a company to provide better treatments and services to customers that generate more profits, such that those customers would continue to stay with the company.

Although it is straightforward to identify profitable customers based on the amount of income or revenue a customer generates, focusing on only revenue or income is not sufficiently accurate in determining the profitability of a customer, because a customer also incurs costs to the company by initiating, or involving in, different types of activities, using services, and/or consumes resources provided by the company, all of which should be considered when determining the profitability of a customer. If costs incurred by a customer exceed the amount of income it generates, even if such customer generates a great amount of revenue or incomes, the company in fact loses money on that customer. For instance, a brokerage firm may have two customers, customer A and customer B, who conduct comparable trading activities and generate comparable revenue. However, the customers may generate different activity patterns that affect the profits the brokerage firm can make on the customers. For example, customer A may prefer to place orders by telephone, which is more costly to the brokerage firm than online transactions. Customer A also may be a heavy user of the brokerage firm's online research resources, which requires the brokerage firm to expand its investments in networking hardware and software in order to accommodate the heavy usage of its networking resources. In addition, customer A may call customer service frequently, which also costs money to the brokerage firm. All of the above activity patterns make customer B a better customer to the brokerage firm than customer A. Moreover, although the brokerage firm may charge the same amount of commissions or fees for different types of transactions, the true costs of each type of transaction may differ, which will affect the brokerage firm's profits. If a customer conducts a lot of transactions that only generate limited profits, even though the amount of commissions received from such customer appears to be impressive, the brokerage company may in fact lose money on this customer.

Therefore, there is a need for a more accurate system or technique to determine the profitability of each customer. There is also a need to accurately identify and determine expenses and incomes arising from activities in connection with a customer or account. There is another need to determine the profitability of a customer in real time.

### SUMMARY OF THE DISCLOSURE

This disclosure presents an activity-driven, profitability calculation method and system that track expenses and/or incomes associated with each activity initiated by customers or accounts. An exemplary method for calculating profitability of an account detects and identifies activities associated with the account, and obtains rate information associated with the identified activities. The rate information specifies any expenses or incomes associated with the identified activities. Furthermore, the rate information may include additional expenses that are incurred or associated with the account, such as material costs (such as forms, postage, etc.), interest payments, and/or marketing costs (printing cost, mailing cost, e-mail cost, etc), and so on. Also, the rate information may include fixed costs that are not specifically associated to a specific customer, but instead spread among all the customers or accounts, such as rent, salaries, utility cost, advertisement cost, etc. A profitability status related to the account, such as an amount of profits or loss, is updated based on the rate information associated with the identified activities. For instance, the method calculates an expense or income incurred by the activity associated with the account, and adds the amount of income to, or subtracts the amount of expense from, the amount of profit or loss already generated by that account. In one aspect, the rate information associated with the identified activity includes a fixed cost and a variable cost varying with the identified activity. In another aspect, since a customer may have several accounts, different accounts associated with the same client may be identified and combined to determine the profitability of that customer.

In one embodiment, the identified activities may incur expenses and incomes at the same time. A calculation is made to determine an overall income or expense relative to the identified activities, and the profitability status of the account is updated accordingly. In another embodiment, an activity initiated by an account or customer includes one or more sub-activities, each of the sub-activities may incur expenses and/or generate incomes. A method according to this disclosure identifies all the sub-activities associated with each activity initiated by an account or a customer. Based on the identified sub-activities, rate information including corresponding expenses or incomes is accessed, and a profitability status of the account or customer is updated based on the accessed rate information.

The profitability status of a customer or an account may be used to determine a service level of that customer or account. The service level determines the type of treatments or services a customer or an account may receive. For instance, the service level may identify the priority to answer a phone call made by the customer, or a type of advertisement or information to be presented to the customer.

A data processing system, such as a computer, may be used to implement the method and system as described herein. The data processing system may include a processor for processing data and a data storage device coupled to the processor, and a data transmission interface. The data storage device bears instructions to cause the data processing system upon execution of the instructions by the processor to perform functions as described herein. The instructions may be embedded in a machine-readable medium to control the data processing system to perform calculations and functions as described herein. The machine-readable medium may include any of a variety of storage media, examples of which include optical storage media, such as CD-ROM, DVD, etc., magnetic storage media including floppy disks or tapes, and/or solid state storage devices, such as memory card, flash ROM, etc. Such instructions may also be conveyed and transmitted using carrier wave type machine-readable media. Data related to activities associated with a customer or account, and corresponding rate information may be stored in one or more databases that implemented in the data storage device and/or any other data storage devices accessible by the data processing system, and may be transferred via a carrier through network communication.

Still other advantages of the presently disclosed methods and systems will become readily apparent from the following detailed description, simply by way of illustration of the invention and not limitation. As will be realized, the activity driven, customer profitability calculation method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic functional block diagram showing the operation of an exemplary activity-driven, profitability calculation system for calculating profitability of a customer or an account.

FIG. 2a depicts an exemplary data structure of a data entry in a customer database.

FIG. 2b depicts an exemplary structure of a data entry in a customer database.

FIGS. 3a and 3b show additional exemplary data structures for a data entry of a rate information database

FIG. 4 depicts a flow chart illustrating an exemplary process for determining a profitability status of an account.

FIG. 5 shows a schematic block diagram of a data processing system upon which an exemplary activity driven, customer profitability calculation system may be implemented.

### DETAILED DESCRIPTIONS OF ILLUSTRATIVE EMBODIMENTS

In the following description, for the purposes of explanation, numerous specific details are set forth in order to provide a thorough understanding of the present subject matter. It will be apparent, however, to one skilled in the art that the present method and system may be practiced without these specific details. In other instances, well-known structures and devices are shown in block diagram form and described in summary functional terms in order to avoid unnecessarily obscuring the present disclosure.

For illustration purpose, the following descriptions discuss an exemplary activity-driven method and system for use in a brokerage firm to calculate profitability of customers or accounts. It is understood that a customer may be associated with one or more accounts set up with the brokerage firm. It is understood that the method and system disclosed herein may apply to many other types of industries or companies, and may have different variations, which are covered by the scope of this application.

For a brokerage firm, a customer or an account may initiate various types of activities that would incur expenses to the brokerage firm, such as obtaining quotes, placing and/or canceling orders (long, short, limit, market, stocks, mutual funds, options, etc.), using online resources, requesting services that need attention by a real person, etc. There are also costs related to keeping a customer or an account, such as material costs (such as forms, postage, etc.), interest payments, and/or marketing costs (printing cost, mailing cost, e-mail cost, etc). Also, there are certain fixed costs that are not specifically applied to a customer, but instead spread over all the customers or accounts, such as rent, salaries, utility cost, advertisement cost, etc. On the other hand, there are numerous ways that a customer or account would generate incomes to a brokerage firm. For example, commissions for different types of transactions, fees charged on managing accounts or purchases, interests or profits generated by customer's funds, fees charged for providing research reports or consultations, etc.

An activity-driven method and system according to this disclosure identify each activity involving, or associated with, a customer or account. One or more databases are provided to store rate information specifying expenses and/or incomes associated with each type of activity. The system accesses rate information related to each identified activity to determine expenses and/or incomes associated with each identified activity. Profitability data that indicates a profitability status corresponding to the customer or account is then updated to indicate a profitability status of the customer or account.

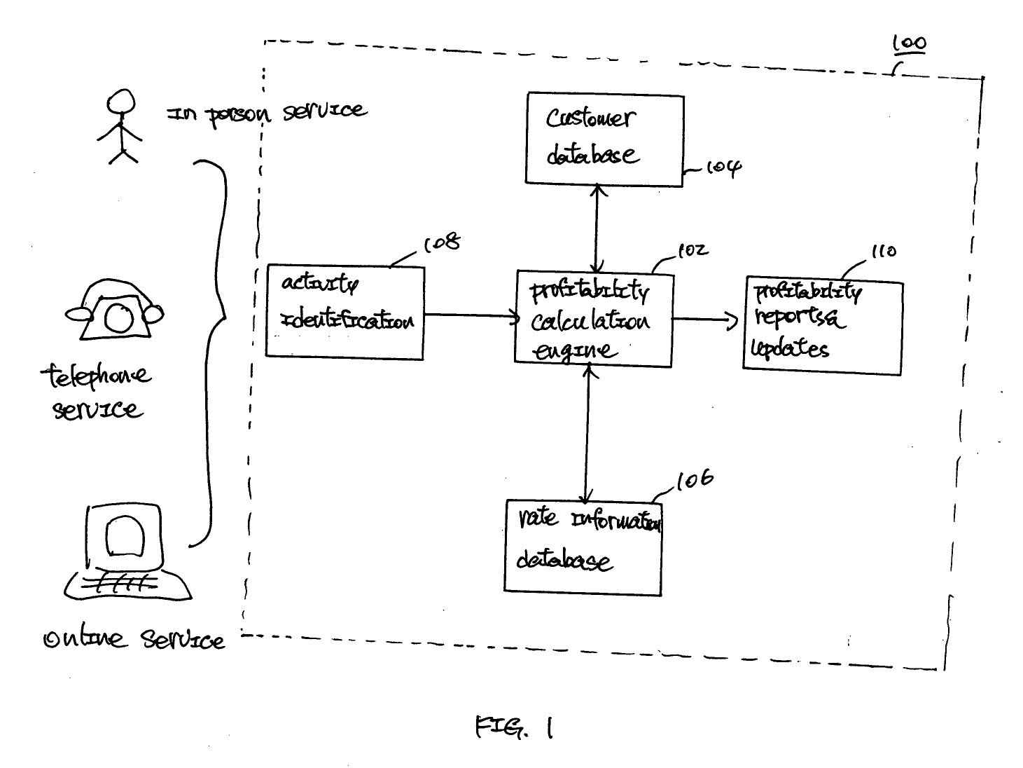

FIG. 1 is a schematic functional block diagram illustrating the operation of an exemplary activity-driven, profitability calculation system 100 for calculating profitability of a customer or an account. System 100 includes a profitability calculation engine 102 having access to a customer database 104 and a rate information database 106. Customer database 102 stores various types of data related to a plurality of customers and/or accounts. The data may include, but is not limited to, account/customer IDs, assets levels, demographic information, activity histories, profitability status, and transaction histories, etc. Customer database 104 provides a data field for storing profitability data to indicate profitability status of each account or customer, such as a profit or a loss and their respective amounts, reflecting expenses and incomes generated by the account during a specific period of time, such as a month, a quarter or since the account was opened to date. For a new account, the initial value of the corresponding profitability data may be set to zero or any number that reflects the costs or profits already associated with the customer or account, such as expenses incurred in obtaining and opening the account, as well as other fixed costs of the brokerage firm that spread among all accounts or customers.

Rate information database 106 stores data specifying expenses and/or incomes associated with each type of activity that the enterprise may provide to a customer or account. The data stored in rate information database 106 may include, but is not limited to, expenses or incomes related for obtaining quotes, placing and/or canceling orders (long, short, limit, market, stocks, mutual funds, options, etc.), using online resources, requesting services that need attention by a real person, commissions for different types of transactions, fees charged on managing accounts or purchases, interests or profits generated by customer's funds, fees charged for providing research reports or consultations, etc. Rate information database 106 also includes data for costs related to keeping a customer or an account, such as material costs (such as forms, postage, etc.), interest payments, and/or marketing costs (printing cost, mailing cost, e-mail cost, etc). Also, the data in rate information database 106 may include fixed costs that are not specifically applied to a customer, but instead spread over all the customers or accounts of the brokerage firm, such as rent, salaries, utility cost, advertisement cost, etc. On the other hand, there are numerous activities that are income sources, that is to say activities of a customer or related to an account that would generate incomes to a brokerage firm. Rate information database 106 also includes rate data for incomes associated with these activities. The rate information for the incomes may include commissions, fees, interests, etc., and may be a fixed number or as a percentage of amounts of transactions. Profitability calculation engine 102, customer database 104 and rate information database 106 may be implemented on one or more data processing systems, such as a single computer, or a distributed computing system including a plurality of computers with network connections.

As shown in FIG. 1, a customer or an account owner may deal with the brokerage firm in different ways, such as using telephones or internet connections, or even visiting the brokerage firm in person. Identities and activities associated with each customer or account are detected, identified and recorded by system 100 (block 108). For instance, a customer who calls the brokerage firm to place an order to purchase stocks may be directed to an automatic transaction system (not shown) to place the order by entering different commands based on designs of the automatic transaction system. The customer may be asked to enter account information first, such as account number, and then enter selections corresponding to placing the order. The automatic transaction system then feeds the account and transaction information to system 100 indicating that an activity associated with a specific account or customer has been initiated. In one embodiment, the automatic transaction system may be part of system 100. In another embodiment, an operator who answers a customer's phone call or a clerk who services a walk-in customer may input the account and transaction information into system 100 manually. If a customer uses internet connections to access resources of the brokerage firm or conduct transactions, the customer may be asked to log in first. After the customer is logged in, the customer's identify is determined. System 100 then identifies and tracks activities associated with the customer, including placing orders, requesting services, obtaining quotes, etc.

Based on the identified activity type, profitability calculation engine 102 accesses rate information database 106 to retrieve rate information corresponding to the activity or transaction associated with the identified account. Continuing to the example used earlier, profitability calculation engine 102 retrieves rate information related to one or more expenses and/or incomes corresponding to placing an order to purchase stocks, and calculates an overall expense or income associated with the activity of placing an order to purchase stocks. For instance, the overall income or expense may be calculated by subtracting all expenses noted in the rate information, such as infrastructure cost, fees charged by Exchanges, cost to report transaction result, etc., from the amount of commissions and/or fees received from the account in connection with the order. Profitability calculation engine 102 then accesses customer database 104 to update the profitability data of the account based on the rate information. Responsive to a net income or loss generated by the activity of placing an order to purchase stocks involving the customer or account, profitability calculation engine 102 adjusts or updates the balance of the profit data accordingly. A profitability report and update 110 may be generated to indicate an updated profitability status of the account or customer.

In one embodiment, the profitability status of a customer is not dynamically calculated and updated. Rather, system 100 records and/or tracks all activities associated with each account or customer, and stores the records in customer database 104. When requested, profitability calculation engine 102 accesses customer database 104 to retrieve data related to all recorded activities associated with an account or customer, based on which profitability calculation engine 102 accesses rate information database 106 to retrieve corresponding rate information to calculate an overall profitability status of the account or customer.

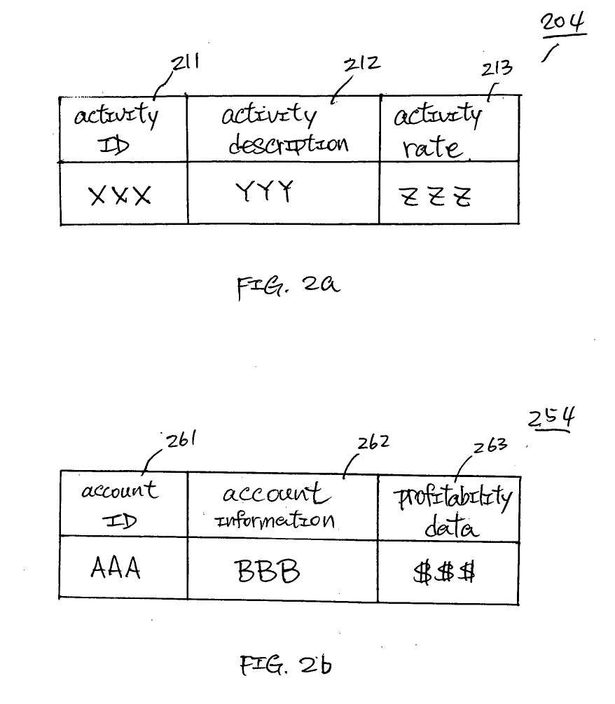

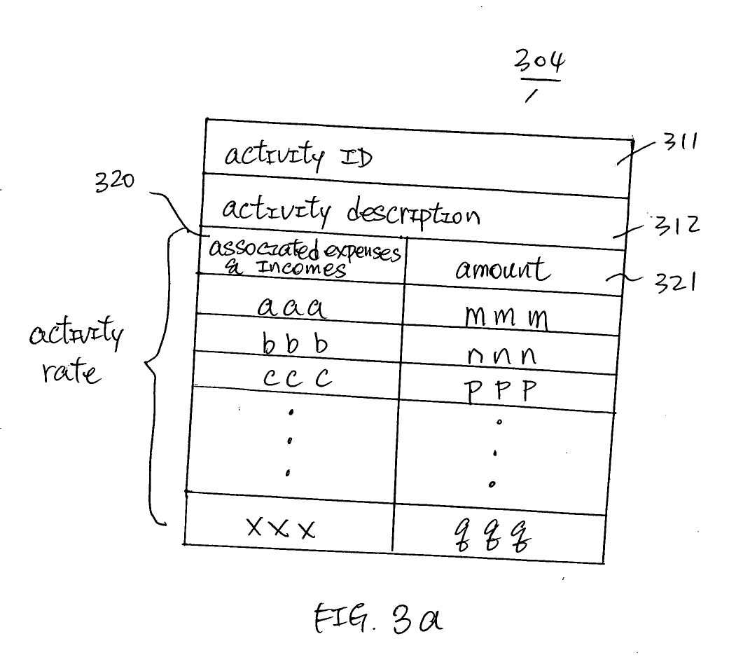

FIG. 2a shows an exemplary data structure of a data entry 204 in rate information database 106. A unique activity ID 211 is assigned to each activity for identification. An activity description 212 associated with activity ID 211 describes details of the activity. An activity rate 213 associated with activity ID 211 indicates at least one corresponding expense and/or income associated with the activity identified by activity ID 211. For example, a telephone call to the customer service center made by a customer may have a corresponding data entry in rate database 106 having an activity ID, call_c_s, an activity description indicating that it is related to a call to the customer service center, and having an activity rate 213 at an expense to the brokerage firm of $0.23 per minute. Activity rate 213 may be a fixed numeral or a variable that is subject to changes from time to time. In one embodiment, the variable is linked to another data entry or database that is updated from time to time to reflect the most updated rates. In another embodiment, activity rate 213 not only reflects true costs associated with the identified activity, but also includes fixed costs of the brokerage firm that are distributed among all accounts or clients. The fixed costs may include, but are not limited to, salaries and benefits of employees, rent of office building, etc. The fixed costs may be distributed among all the accounts evenly or on a weighted basis depending on different attributes of accounts, such as assets levels, transaction amounts, etc.

FIG. 2b depicts an exemplary data structure of a data entry 254 in customer database 104. A unique account ID 261 is assigned to each account for identification. An account information field 262 associated with account ID 261 stores detail information related to the account, such as the name of the account owner, demographic data of the owner, type of account, etc. A data field 263 associated with each account ID 261 is provided to store profitability data that indicates a profitability status of the associated account, such as the amount of loss or profit, reflecting expenses and/or incomes generated by the account during a specific period of time, such as a month, a quarter or since the account was opened to date. As discussed previously, for a new account, the initial value of the corresponding profitability data may be set to zero or any number that reflects the costs or profits already associated with the customer or account, such as expenses incurred in obtaining and opening the account, as well as other fixed costs of the brokerage firm that spreads among every account or customer.

Continuing to the earlier example related to a phone call to the customer service center by a customer, after the customer calls the customer service center, the identity of the customer and/or the associated account, as well as the phone call are identified as discussed earlier. The duration of the phone call is also recorded. Responsive to the phone call, profitability calculation engine 102 accesses rate information database 106 to access rate information corresponding to phone calls to the customer service center, and determines that the activity rate for phone calls to customer service center is an expense at $0.23 per minute. Profitability calculation engine 102 then multiplies the duration of the phone call by $0.23 per minute to determine the overall expense of the brokerage firm resulting from the phone call associated with the account. Profitability calculation engine 102 then accesses account data stored in customer database 104 based on the account identity, such as account ID, and updates profitability data corresponding to the account to reflect the overall expense coming from the phone call to the customer service center. In one embodiment, profitability calculation engine 102 further generates or updates a profitability report reflecting the changes of the profitability status of the account. The profitability report may be in the form of a machine-readable file, which can be accessed by other systems. For instance, different types or levels of services may be provided to customers based on their respective profitability statuses. For instance, the report may be accessed by a computer in a calling center to discriminate between incoming calls to determine which calls should be answered at a higher priority based on how profitable the calling customer is to the brokerage firm. A phone call made by a first customer with higher profitability to the firm should be given a higher priority and thus answered faster and/or by a more skilled resporident than a phone call made by a second customer with lower profitability to the firm, even though the second customer may have called first.

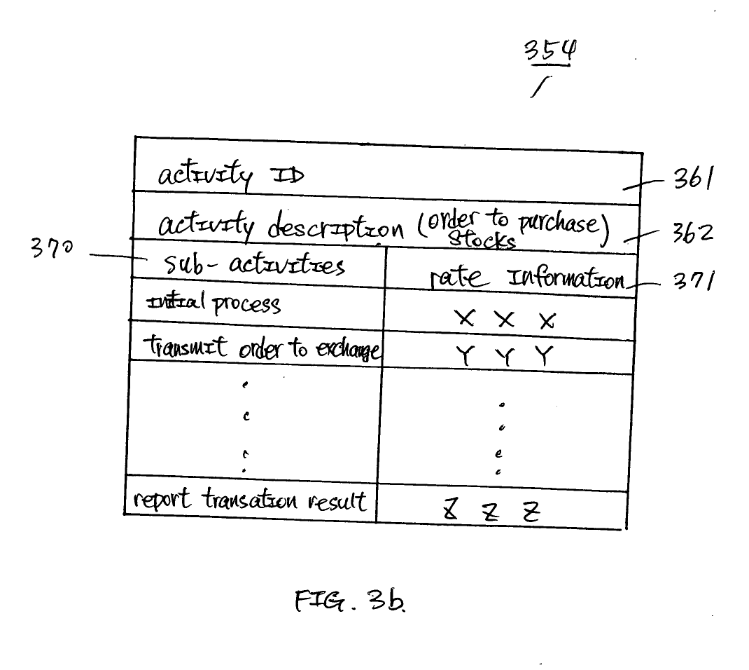

FIG. 3a shows another exemplary data structure for a data entry 304 of rate information database 106. Similar to the data entry 104 shown in FIG. 2a, data entry 304 includes a unique activity ID 311 assigned to each activity, and an activity description 312 associated with activity ID 311 describing details of the activity. The activity rate field of data entry 304 includes a plurality of subsections identifying numerous types of expenses and incomes 320 and their respective amounts 321 associated with the activity identified by activity ID 311. For example, an activity related to “request for forms” initiated by a customer may involve four types of expenses to fulfill the request: cost of forms, mailing cost, service fees charged by fulfillment agency, and cost for tracking. Thus, a data entry 304 corresponding to “request for forms” will store information related to the four types of expenses as identified earlier in the associated expenses and incomes field 320, and their respective amounts field 321. The amounts may be fixed numbers or variables that are subject to changes from time to time. In one embodiment, one or more variables are linked to another data entry or database that is updated from time to time to reflect the most updated rates. In operation, when system 100 identifies an activity associated with an account requesting forms, profitability calculation engine 102 accesses rate information database 106 to determine all expenses listed in data field 321 and calculates an overall expense, and updates the profitability status of the account accordingly.

FIG. 3b depicts another exemplary data structure for a data entry 354 of rate information database 106. Similar to the data entry 104 shown in FIG. 2a, data entry 304 includes a unique activity ID 361 assigned to each activity, and an activity description 362 associated with activity ID 361 describing details of the activity. In this example, the activity is an order to purchase stocks. Data entry 354 includes a data field 370 identifying a plurality of sub-activities that are associated with the order to purchase stocks, such as initial process of the order, transmit the order to Exchanges (NYSE, NASDAQ, etc.), and report transaction result to customer. Data field 371 stores rate information corresponding to each sub-activity listed in data field 370. The rate information stored in field 371 may include one or more incomes and/or expenses associated with each sub-activity. In operation, when system 100 identifies an activity associated with an account to place an order to purchase stocks, profitability calculation engine 102 accesses rate information database 106 to determine all sub-activities listed in data field 370 and calculates an overall expense based on the rate information stored in data filed 371. Profitability calculation engine 102 then updates the profitability status of the account according to the calculation result.

According to another embodiment, a profitability status of an account or customer is not dynamically calculated and updated. Rather, system 100 keeps track of all activities involving each account and maintains an activity history in customer database 104. Upon receiving a request for the profitability status of a specific account, profitability calculation engine 102 accesses customer database 104 to retrieve all activities associated with the account during a specific period of time, and retrieves rate information corresponding to the activities by accessing rate information database 106. Rate information database 106 may store rate information for each activity using the data structures illustrated in FIG. 2b, FIG. 3a or FIG. 3b, or any combinations thereof. Based on the activity history stored in customer database 104 and rate information retrieved from rate information database 106, profitability calculation engine 102 calculates an overall expense or income for all the activities associated with the account, and generates a profitability status of the account according to the calculation result.

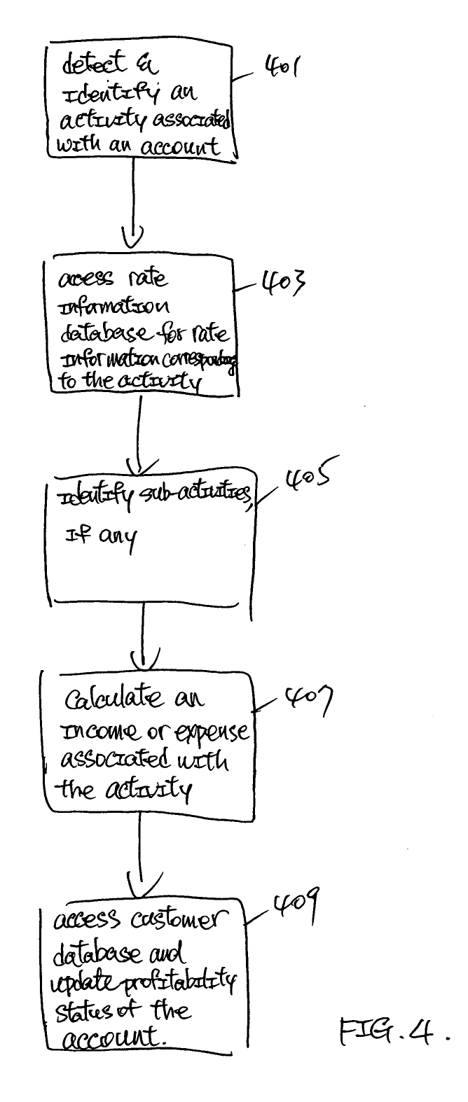

FIG. 4 depicts a flow chart illustrating an exemplary process for determining a profitability status of an account. In Step 401, system 100 detects and identifies an activity associated with an account. In Step 403, profitability calculation engine 102 accesses rate information database 106 for rate information corresponding to the identified activity. Profitability calculation engine 102 further determines any sub-activities associated with the identified activity, if any, based on the rate information (Step 405). System 100 then calculates an overall income or expense resulting from the identified activity, and accesses customer database 104 to update the profitability status of the account based on the calculated income or expense (Steps 407 and 409).

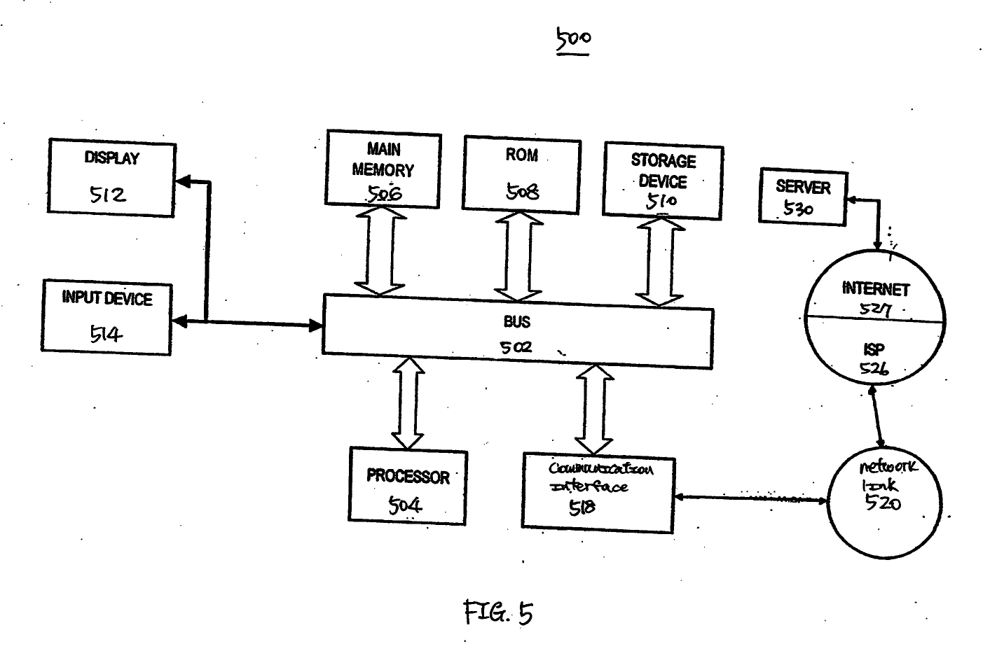

FIG. 5 shows a block diagram of an exemplary data processing system 500 upon which the activity driven, customer profitability calculation system 100 may be implemented. As discussed earlier, system 100 may be implemented with a single data processing system 500 or a plurality of data processing systems 500 connected by data transmission networks. The data processing system 500 includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

The data processing system 500 may also have suitable software and/or hardware for converting data from one format to another. An example of this conversion operation is converting format of data available on the system 500 to another format, such as a format for facilitating transmission of the data. The data processing system 500 may be coupled via bus 502 to a display 512, such as a cathode ray tube (CRT), plasma display panel or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510 or carrier received via communication interface 518. Execution of the sequences of instructions contained in main memory 506 causes processor 504 to perform the process steps described herein.

In one embodiment, profitability calculation engine 102 of the activity-driven, customer profitability calculation system 100 is implemented by processor 504 under the control of suitable instructions stored in storage device 510. For instance, under the control of pre-stored instructions, the data processor 504 accesses customer data and rate information stored in the data storage device 510 and/or other data storage device coupled to the data processing system, and calculates and updates the profitability status of a customer. In alternative embodiments, hard-wired circuitry may be used in place of or in combination with software instructions to implement the disclosed calculations. Thus, the embodiments disclosed herein are not limited to any specific combination of hardware circuitry and software.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or external network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal, and appropriate circuitry can place the data on bus 502. Of course, a variety of broadband communication techniques/equipment may be used for any of those links. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local ISP network 526 and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518. In the Internet example, a server 530 might transmit a requested code for an application program through Internet 527, ISP 526, local network and communication interface 518. The program, for example, might implement calculation of customer profitability, as outlined above. The communications capabilities also allow loading of relevant data into the system, for processing in accord with this disclosure.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

The system and method as discussed herein may be implemented using a single data processing system, such as a single PC, or a combination of a plurality of data processing systems of different types. For instance, a client-server structure or distributed data processing architecture can be used to implement the system disclosed herein, in which a plurality of data processing systems are coupled to a network for communicating with each other. Some of the data processing systems may serve as servers handling data flow, providing calculation services or access to customer data, and/or updating software residing on other data processing systems coupled to the network.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

What is claimed is:

1. A method for calculating profitability of an account, comprising the steps of:
detecting an activity associated with the account;
identifying the activity;
accessing rate information associated with the identified activity, wherein the rate information includes at least one expense or income associated with the identified activity; and
updating profitability data indicating a profitability status related to the account based on the rate information associated with the identified activity.

2. The method of claim 1, wherein the account is associated with a customer.

3. The method of claim 1 further comprising a step of calculating an overall income or an overall expense associated with the identified activity based on the rate information associated with the identified activity.

4. The method of claim 3, wherein the step of updating profitability data related to the account comprises the steps of:
responsive to the activity incurring an overall expense, subtracting the amount of the overall expense from the profitability data related to the account; and
responsive to the activity generating an overall income, adding the amount of the overall income to the profitability data related to the account.

5. The method of claim 1, wherein the step of accessing rate information associated with the identified activity includes the steps of:
identifying at least one sub-activity associated with the identified activity; and
accessing rate information of each of the at least one identified sub-activity associated with the identified activity, wherein the rate information of each of the at least one identified sub-activity includes at least one expense or income associated with each of the at least one identified sub-activity.

6. The method of claim 1, wherein the profitability data related to the account is stored in a non-volatile memory.

7. The method of claim 1, wherein the rate information associated with the identified activity includes a fixed cost and a variable cost varying with the identified activity.

8. The method of claim 1 further including a step of generating a profitability report for the account based on the profitability data related to the account.

9. The method of claim 1 further including a step of determining a service level of a customer associated with the account based on the profitability data related to the account.

10. The method of claim 9, wherein the service level identifies the priority of answering a phone call made by the customer.

11. The method of claim 9, wherein the service level identifies a type of advertisement or information to be presented to the customer.

12. The method of claim 1, wherein the method is machine-implemented.

13. A data processing system for calculating profitability of an account, comprising:
a processor for processing data;
a data storage device coupled to the processor;
the data storage device bearing instructions to cause the data processing system to perform the steps of:
detecting an activity associated with the account;
identifying the activity;
accessing rate information associated with the identified activity, wherein the rate information includes at least one expense or income associated with the identified activity; and
updating profitability data related to the account based on the rate information associated with the identified activity.

14. The system of claim 13, wherein the account is associated with a customer.

15. The system of claim 13, wherein the data storage device further bears instructions to cause the data processing system to perform a step of calculating an overall income or an overall expense associated with the identified activity based on the rate information associated with the identified activity.

16. The system of claim 15, wherein the step of updating profitability data related to the account comprises the steps of:
responsive to the activity incurring an overall expense, subtracting the amount of the overall expense associated with the activity from the profitability data related to the account; and
responsive to the activity generating an overall income, adding the amount of the overall income associated with the activity to the profitability data related to the account.

17. The system of claim 13, wherein the step of accessing rate information associated with the identified activity includes the steps of:
identifying at least one sub-activity associated with the identified activity; and
accessing rate information associated with each of the at least one identified sub-activity associated with the identified activity, wherein the rate information associated with each of the at least one identified sub-activity includes at least one expense or income associated with the identified sub-activity.

18. The system of claim 13, wherein the profitability data related to the account is stored in a non-volatile memory.

19. The system of claim 13, wherein the rate information associated with the identified activity includes a fixed cost and a variable cost varying with the identified activity.

20. The system of claim 13, wherein the data storage device further bears instructions to cause the data processing system to perform a step of generating a profitability report for the account based on the profitability data related to the account.

21. The system of claim 13, wherein the data storage device further bears instructions to cause the data processing system to perform a step of determining a service level of a customer associated with the account based on the profitability data related to the account.

22. The system of claim 21, wherein the service level identifies the priority of answering a phone call made by the customer.

23. The system of claim 21, wherein the service level identifies a type of advertisement or information to be presented to the customer.

24. A program comprising instructions, which may be embodied in a machine-readable medium, for controlling a data processing system to calculate profitability of an account, the instructions upon execution by the data processing system causing the data processing system to perform the steps as in the method of claim 1.

25. The program of claim 24, wherein the account is associated with a customer.

26. The program of claim 24 further comprising instructions to control the data processing system to perform a step of calculating an overall income or an overall expense associated with the identified activity based on the rate information associated with the identified activity.

27. The program of claim 26, wherein the step of updating profitability data related to the account comprises the steps of:
responsive to the activity incurring a cost, subtracting the amount of the overall expense associated with the activity from the profitability data related to the account; and
responsive to the activity generating an income, adding the amount of the overall income associated with the activity to the profitability data related to the account.

28. The program of claim 24, wherein the step of accessing rate information associated with the identified activity includes the steps of:
identifying at least one sub-activity associated with the identified activity; and
accessing rate information associated with each of the at least one identified sub-activity associated with the identified activity;
wherein the rate information associated with each of the at least one identified sub-activity includes an expense or an income associated with the identified sub-activity.

29. The program of claim 24, wherein the profitability data related to the account is stored in a non-volatile memory.

30. The program of claim 24, wherein the rate information associated with the identified activity includes a fixed cost and a variable cost varying with the identified activity.

31. The program of claim 24 further comprising instructions to control the data processing system to perform a step of generating a profitability report for the account based on the profitability data related to the account.

32. The program of claim 24 further comprising instructions to control the data processing system to perform a step of determining a service level of a customer associated with the account based on the profitability data related to the account.

33. The program of claim 32, wherein the service level identifies the priority of answering a phone call made by the customer.

34. The program of claim 32, wherein the service level identifies a type of advertisement or information to be presented to the customer.

35. A method for calculating profitability of an account, comprising the steps of:
recording each activity associated with the account;
accessing rate information of each recorded activity associated with the account, wherein the rate information of each activity associated with the account includes at least one expense or income associated with each recorded activity; and
calculating a profitability status of the account based on the rate information of each recorded activity associated with the account.
